(19) United States
(12) Patent Application Publication
(10) Pub. No.: US 2025/0331499 A1
(43) Pub. Date: Oct. 30, 2025

(54) SECURING STRAP FOR TOY LAUNCHER

(71) Applicant: Rolf C. Hagen Inc., Baie d'Urfé (CA)

(72) Inventor: Lucas De Boeck, Putte (BE)

(21) Appl. No.: 18/646,138

(22) Filed: Apr. 25, 2024

(51) Int. Cl. A01K 15/02

(52) U.S. Cl. CPC A01K 15/025

(57) ABSTRACT

A toy launcher is provided. In some embodiments, the toy launcher includes a strap configured to secure a toy into a toy receiver of the toy launcher. In some embodiments, the strap is configured to be secured across an opening of the toy receiver in an engaged configuration. In some embodiments, the strap is configured to be secured to a handle of the toy launcher in a disengaged configuration.

### FIELD

The field relates to toy launchers.

### BACKGROUND

Toy launchers are often used to enhance a user's throwing ability. Such launchers are often used to increase a user's throwing range during activities, such as when playing fetch with a dog. Such launchers often include a toy receiver at a distal end of the toy launcher, and a handle at a proximal end of the toy launcher. The toy receiver is configured to grip a toy, such as a ball. In use, a user may grasp the handle portion and rotate their arm in a throwing motion. As the user rotates their arm, the toy releases from the toy receiver. The launcher serves to increase the lever arm distance of a user's arm during a throwing motion, thus increasing a user's output force on the ball. Users may also us the toy receiver to retrieve the toy, so that a user does not need to touch the toy with their hands during retrieval.

### SUMMARY

In some embodiments, a toy launcher is disclosed. The toy launcher comprising a handle, a toy receiver disposed at a distal end of the handle, the toy receiver comprising an opening configured to allow a toy to enter and exit the toy receiver, and a strap configured to move between an engaged configuration and a disengaged configuration, where in the engaged configuration, the strap is configured to aid in securing a toy in the toy receiver.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 shows a side view of a toy launcher according to an embodiment;

FIG. 2 shows a sectional side view of a toy launcher with a strap in an engaged configuration according to an embodiment;

FIG. 3 shows a sectional side view of a toy launcher with a strap in a disengaged configuration according to an embodiment;

FIG. 4 shows a sectional front view of a toy launcher with a strap in a disengaged configuration according to an embodiment;

FIG. 5 shows a cross-sectional side view of a toy launcher taken along line 5-5 of FIG. 4, with a securing strap in a disengaged configuration according to an embodiment;

FIG. 6A shows a side view of a securing strap according to an embodiment; and

FIG. 6B shows a front view of the securing strap of FIG. 6A.

### DETAILED DESCRIPTION

People often use toy launchers to improve their throwing performance when throwing toys, especially when playing with pets (e.g. playing fetch with a dog). Such toy launchers include a toy receiver configured to grip a toy, and a handle for the user to grasp. In use, the user places a toy into the toy receiver, grasps the handle, and rotates the toy launcher in a throwing motion. During the throwing motion, the toy is released from the toy receiver and flies forward. Distance between the handle and the toy receiver serves to increase the lever arm distance between the toy and the fulcrum of the user's arm during a throw (e.g. the user's elbow), increasing the output force on the toy and resulting in improved throwing performance.

In order to release the toy during a throw, the toy receiver must grip the ball relatively loosely during a throwing operation. While such a loose grip may be desirable during use, such a loose grip may be undesirable when the toy launcher is not in use (e.g. while traveling to a park to play fetch, while storing the toy launcher, etc.) because the toy may fall out of the toy receiver and become lost.

The inventors have therefore recognized an advantage to securing the toy in the toy receiver while the toy launcher is not in use to reduce the risk of the toy falling out of the toy receiver. The inventors have also recognized that it may be desirable to secure the toy without enclosing the toy. For instance, the toy may become wet during use (e.g. from dog saliva, from being thrown into a body of water, etc.), and leaving the toy unenclosed in the toy receiver may allow the toy to dry properly.

Therefore, in some embodiments, the toy launcher may include a strap. The strap may be configured move between an engaged configuration and a disengaged configuration. In the engaged configuration, the strap may extend across an opening of the toy receiver and secure a toy inside of the toy receiver. When in the engaged configuration, the toy may still be exposed to the surrounding environment to allow for proper drying. In the disengaged configuration, the strap may be positioned such that the strap does not extend across the opening of the toy receiver and does not secure a toy inside of the toy receiver, allowing a toy to be thrown from the toy receiver. In some embodiments, the strap may be secured to the toy launcher while in the disengaged position. Such a configuration may limit the likelihood of the strap becoming lost when disengaged, and may limit interference from the strap when throwing a toy.

In some embodiments, the toy receiver is positioned at a distal end of the handle. In some embodiments, the toy launcher may include a first anchor disposed proximal to the toy receiver and a second anchor disposed on a distal side of the toy receiver. The first anchor may be disposed on a proximal side of the toy receiver, or on a portion of the handle adjacent to the toy receiver. The strap may include slots configured to interlock with the first and second anchors when the strap is in the engaged configuration. In some embodiments, the toy launcher includes a third anchor disposed proximal to the first anchor, and the slots on the strap are configured to interlock with the first and third anchors when the strap is in the disengaged configuration.

In some embodiments, the strap may be adjustable to allow for insertion of different sizes and shapes of toys into the receiver slot. In some embodiments, the strap may be an elastic strap to allow the strap to conform to different shapes and sizes of toys, and to exert additional force on the toy to retain the toy in the toy receiver. In some embodiments, the elastic strap may be formed of any suitable material, such as silicone, natural rubber, thermoplastic rubber, thermoplastic elastomers, thermoplastic polyurethane, any other elastomer or elastic material, or any combination of suitable materials. In some embodiments, the elastic strap is formed of a combination of elastic and non-elastic materials. In some embodiments, the strap may be a non-elastic strap, and may be adjustable using a cinch or other tightening mechanism. In some embodiments, the strap may be non-adjustable, and configured to only secure a specifically sized toy.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

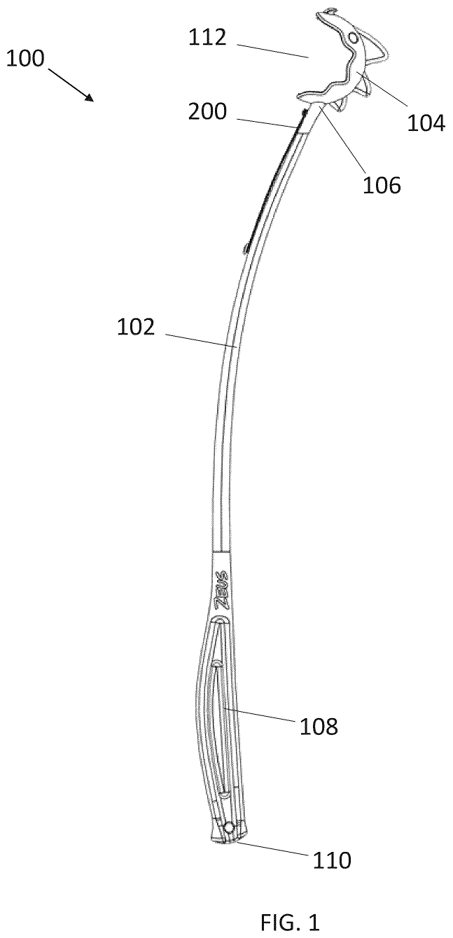

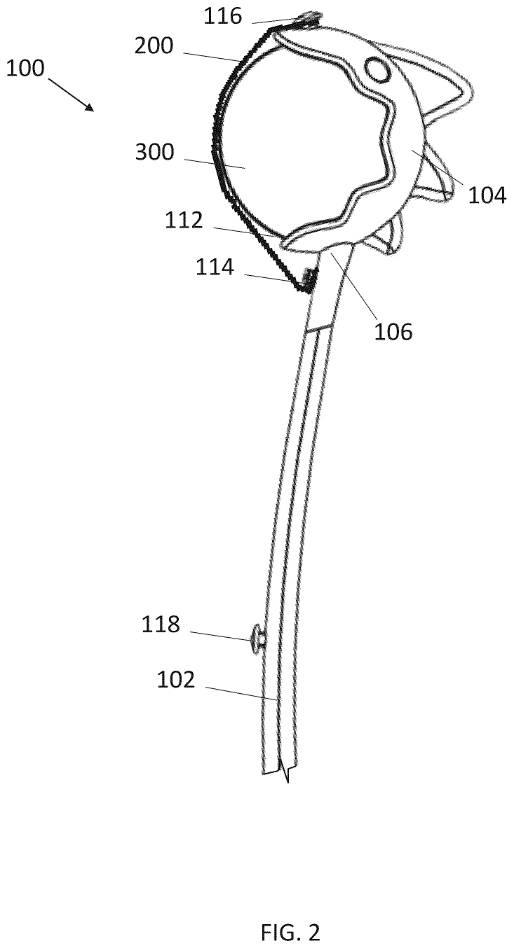

FIG. 1 shows a side view of a toy launcher 100 according to an embodiment. FIGS. 2-4 show sectional side views of the toy launcher 100 according to embodiments.

The toy launcher includes a handle 102 and a toy receiver 104 disposed at a distal end 106 of the handle 102. The toy receiver may be configured to receive a toy 300 (e.g. a ball, or any other suitable toy which may be gripped in toy receiver 104) into opening 112 for throwing. Toy 300 may enter opening 112 prior to throwing, and exit opening 112 during a throw. The toy receiver 104 may be configured to grasp the toy 300 relatively loosely, such that the toy 300 may be released from the toy receiver during a throwing motion. The toy launcher may include a grip 108 disposed at a proximal end 110 of the handle for receiving a hand of a user.

As discussed above, it may be desirable for the toy launcher 100 to be configured to secure the toy in the toy receiver 104 when the toy launcher 100 is not in use. It may also be desirable for the toy to remain unenclosed when the toy is secured in the toy receiver. The toy launcher may therefore include a strap 200 configured to extend across opening 112 in an engaged configuration, as seen in FIG. 2. When a toy 300 is disposed in the toy receiver 104, and the strap 200 is in the engaged configuration, strap 200 secures the toy 300 into the toy receiver 104, preventing the toy 300 from exiting the toy receiver 104 via the opening 112 while leaving toy 300 exposed to the surrounding environment. It may also be desirable for the strap 200 to be secured in place when not in the engaged configuration. This may be desirable to limit the likelihood of losing the strap, and may also limit interference from the strap when throwing a toy. The strap 200 may therefore be configured to be secured to a portion of the toy launcher 100 in a disengaged configuration.

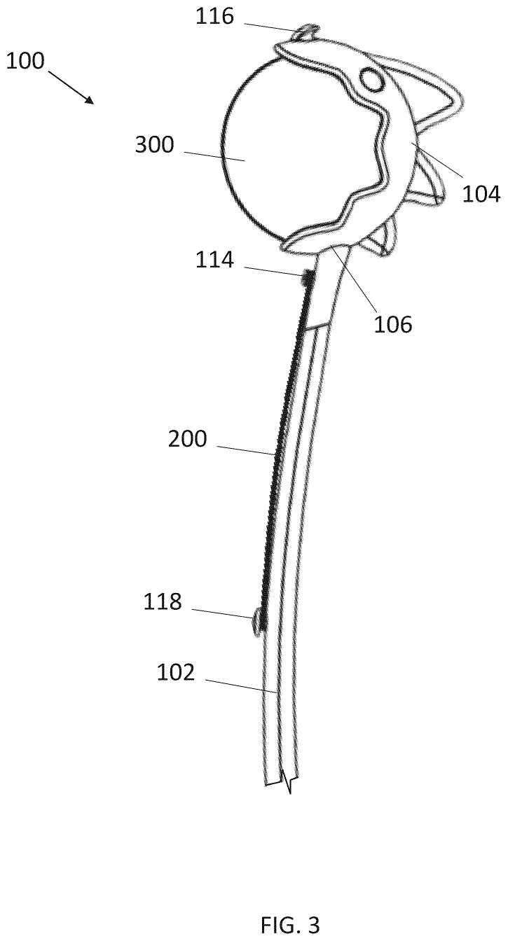

Strap 200 may be attached to the toy launcher 100 in any suitable orientation which allows for the strap to secure the toy 300 in place when in the engaged configuration, and which allows for the toy 300 to be released from the toy receiver 104 when in the disengaged configuration. For instance, when in the engaged configuration, the strap 200 may extend from first anchor 114 disposed on handle 102 to second anchor 116 disposed on a distal side of the toy receiver 104. Alternatively, first anchor 114 may be located on a proximal side of the toy receiver 104. When in the disengaged configuration, as shown in FIG. 3, the strap 200 may extend from first anchor 114 to third anchor 118 disposed on the handle 102 proximal to the first anchor 114.

While the strap extends proximally-laterally in the engaged and disengaged configurations in the above embodiments, it is contemplated that the strap may be anchored in any suitable manner which allows it to extend across the opening in the engaged configuration. For instance, in some embodiments, first and second anchors may be disposed on lateral sides of the toy receiver. The strap may be configured to interlock with the first and second anchors in both the engaged configuration and the disengaged configuration, such that the strap extends laterally across an opening of the toy receiver when in the engaged configuration, and such that the strap extends across a rear surface of the toy receiver when in the disengaged configuration. In some embodiments, the strap is removable in the disengaged configuration.

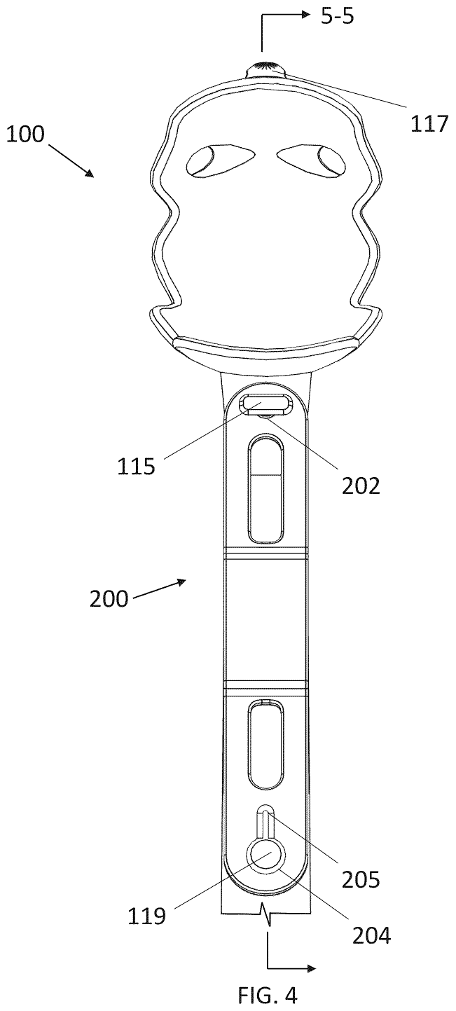

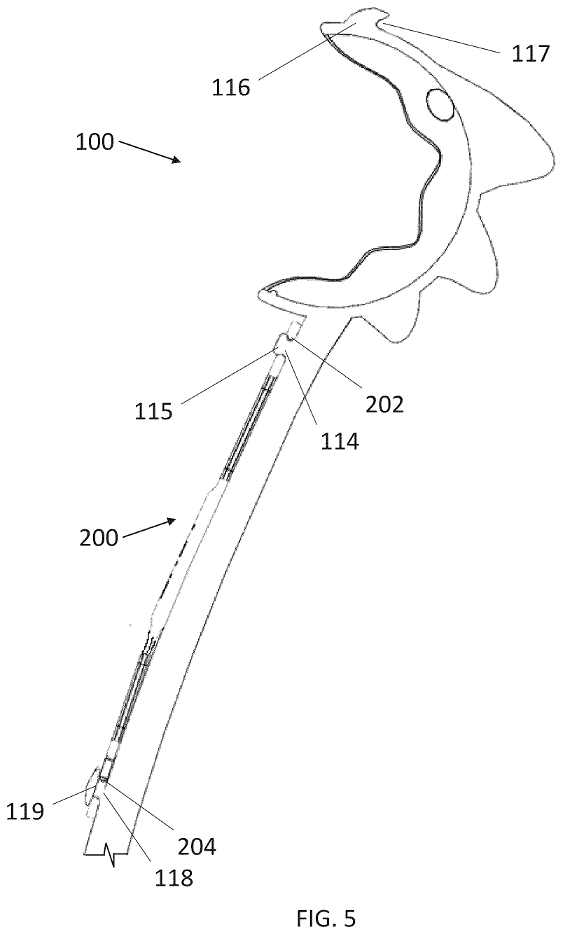

FIGS. 4 and 5 show a front view and cross-sectional side view of toy launcher 100 with strap 200 attached in a disengaged configuration.

Strap 200 may be secured into the engaged and disengaged configurations using any suitable fasteners. For instance, as seen in FIGS. 4 and 5, strap 200 may include first receiving slot 202 and second receiving slot 204. First receiving slot 202 may be configured to slot over projection 115 of first anchor 114, and second receiving slot 204 may be configured to slot over projection 117 of second anchor 116 in the engaged configuration, and over projection 119 of third anchor 118 in the disengaged configuration. In some embodiments, projection 117 and/or projection 19 may be hooked projections. In some embodiments, strap 200 may be configured to rotate about first receiving slot 202 and first anchor 114 when moving between the engaged and disengaged configurations. In some embodiments, second receiving slot 204 may include a relief slot 205 to allow for more convenient attachment of second receiving slot 204 to the second and third anchors.

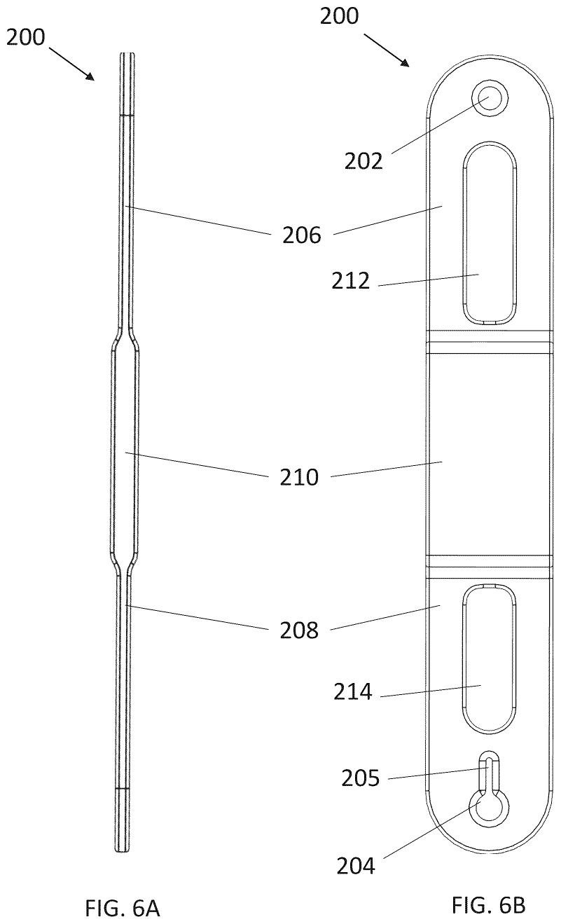

FIGS. 6A and 6B show side and front views of strap 200 according to an embodiment.

Strap 200 may be formed of any suitable material which allows for securing of the toy 300 in the toy receiver 104, such as elastomers, textiles, etc. In some embodiments, it may be desirable for the strap 200 to be adjustable to allow for the securement of toys having different sizes and/or shapes. Strap 200 may therefore be formed of an elastic material configured to stretch as it is pulled over the toy 300 when moved to the engaged configuration. Such an elastic strap 200 may also allow the strap to exert force against the toy 300 when in the engaged configuration, further biasing the toy 300 into the toy receiver 104. The elastic strap 200 may be formed of any suitable material, such as silicone, natural rubber, thermoplastic rubber, thermoplastic elastomers, thermoplastic polyurethane, any other elastomer or elastic material, or any combination of suitable materials. In some embodiments, the elastic strap is formed of a combination of elastic and non-elastic materials. It should be noted that any suitable adjustable strap is contemplated, such as a cinch strap, or that strap 200 may not be adjustable at all in some embodiments, as the disclosure is not so limited.

When an elastic strap 200 is used, as seen in FIGS. 6A and 6B, strap 200 may include a thicker central portion 210 between first end portion 206 and second end portion 208. Such a thicker central portion may allow for greater holding force from the strap 200 in the engaged configuration. In some embodiments, first end portion 206 may include first relief slot 212, and second end portion 208 may include second relief slot 214. Such relief slots 212 and 214 may allow for easier stretching of the strap around toy 300 in the engaged configuration.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A toy launcher comprising:
a handle;
a toy receiver disposed at a distal end of the handle, the toy receiver comprising an opening configured to allow a toy to enter and exit the toy receiver;
a strap configured to move between an engaged configuration and a disengaged configuration, where, in the engaged configuration, the strap is configured to aid in securing a toy in the toy receiver, wherein the strap is configured to extend across the opening in the engaged configuration;
a first anchor disposed on the handle, and a second anchor disposed on a distal side of the toy receiver, wherein the strap is configured to engage with the first and second anchors when the strap is in the engaged configuration; and
a third anchor disposed on the handle proximal to the first anchor, and wherein the strap is configured to engage with the first and third anchors when the strap is in the disengaged configuration,
wherein the first, second, and third anchors comprise projections, and the strap comprises a first receiving slot configured to interlock with the first anchor, and a second receiving slot configured to interlock with the second anchor in the engaged configuration and with the third anchor in the disengaged configuration.

2. (canceled)

3. The toy launcher of claim 1, wherein the strap is configured to extend from the handle to a distal side of the toy receiver when the strap is in the engaged configuration.

4. The toy launcher of claim 1, wherein the strap is configured to extend from a proximal side of the toy receiver to a distal side of the toy receiver when the strap is in the engaged configuration.

5.-7. (canceled)

8. The toy launcher of claim 1, wherein the second receiving slot comprises a relief slot configured to allow the relief slot to interlock with the third anchor.

9. The toy launcher of claim 1, wherein the first receiving slot is disposed in a first portion of the strap, and the second receiving slot is disposed in a second portion of the strap, and further comprising a third portion of the strap between the first portion and second portion, the third portion having a greater thickness than the first portion and the second portion.

10. The toy launcher of claim 9, further comprising relief slots in the first portion and second portions separate from the first and second receiving slots.

11. The toy launcher of claim 1, wherein the strap is formed of an elastic material.
